(19) United States
(12) Patent Application Publication
(10) Pub. No.: US 2008/0126751 A1
(43) Pub. Date: May 29, 2008

(54) SCHEDULER HINT METHOD AND SYSTEM TO IMPROVE NETWORK INTERFACE CONTROLLER (NIC) RECEIVE (RX) PROCESSING CACHE PERFORMANCE

(76) Inventors: Shay Mizrachi, HaSharon (IL); Eliezer Tamir, Beit Shemesh (IL)

Correspondence Address: MCANDREWS HELD & MALLOY, LTD, 500 WEST MADISON STREET, SUITE 3400, CHICAGO, IL, 60661, US

(21) Appl. No.: 11/945,510

(22) Filed: Nov. 27, 2007

Related U.S. Application Data
(60) Provisional application No. 60/867,286, filed on Nov. 27, 2006.

(51) Int. Cl. G06F 9/30

(52) U.S. Cl. 712/30; 712/E09.016

(57) ABSTRACT

Aspects of a scheduler hint method and system to improve network interface controller (NIC) receive (RX) processing cache performance are presented. Aspects of a system may include a NIC that enables generation of a processor selection bias value. The processor selection bias value may comprise hint data. A scheduler within a multiprocessor operating system (OS) executing on a multiprocessor computing system may enable selection of one of a plurality of processors based on the generated processor selection bias value. The scheduler executing on the multiprocessor computer system may enable execution of specified code, for example an egress process task, on the selected one of the plurality of processors. The egress process task may be executing subsequent to an ingress task process, which was executed on the selected one of the plurality of processors in response to one or more data packets received at the NIC.

### CROSS-REFERENCE TO RELATED APPLICATIONS/INCORPORATION BY REFERENCE

This application makes reference to, claims priority to, and claims the benefit of U.S. Provisional Application Ser. No. 60/867,286, filed on Nov. 27, 2006, which is hereby incorporated herein by reference in its entirety.

### FIELD OF THE INVENTION

Certain embodiments of the invention relate to multiprocessor computing systems. More specifically, certain embodiments of the invention relate to a scheduler hint method and system to improve network interface controller (NIC) receive (RX) processing cache performance.

### BACKGROUND OF THE INVENTION

High performance multiprocessor computer systems may utilize “optimized” architectures that may comprise nonstandard memory, bus and interconnect components. Many such systems utilize operating systems (OS), which manages the hardware resources within the multiprocessor computer system. For example, the OS may comprise a scheduler, which schedules process tasks for execution. In addition to determining a time interval during which a process task may be executed, the scheduler may also assign the process task to a specific processor, among the group of processors in the multiprocessor computer system, which may execute the process task at the scheduled time interval.

The scheduler may utilize various criteria when scheduling a process task for execution. For example, the scheduler may assign process tasks among processors to enable even distribution of the processing workload among the processors. For example, the scheduler may attempt to assign process tasks based on assessments of idle time for each of the processors; a process task may be assigned to the processor, which has had more idle time than other processors.

The scheduler may schedule tasks based on software events and/or hardware interrupt events. For example, a process task may represent an instance of a network layer application, such as an Internet Protocol (IP) application, sending or receiving data on a network interface card (NIC). The network layer process task may generate an interrupt event when a data packet is received via a network. The network layer process task may generate an interrupt event, such as an RX (receive) completion event to indicate reception of a data packet or a TX (transmit) completion event to indicate successful transmission of a data packet to a network. The interrupt event may be communicated to an interrupt service routine (ISR). The ISR may invoke a task, which represents an instance of a transport layer application, such as a transmission control protocol (TCP) application. The transport layer task may be invoked by calling a software function, such as a receive syscall (system call) to indicate reception of a data packet, or a transmit syscall to indicate transmission of a data packet. The syscall may invoke services from the OS, such as those of the scheduler, which may notify the scheduler to schedule the transport layer process task for execution. The scheduler may assign the transport layer process task to a processor for execution. The processor may execute the transport layer process task as a deferred procedure call (DPC). The processor may suspend execution of the transport layer process task, in which case the process task may be referred to as having gone “to sleep”. At a later time instant, the scheduler may assign the sleeping process task for further execution on a processor. In this case, the process task may be referred to as “waking up”. The scheduler may assign to awakening process task to a different processor for further execution.

The memory architecture within a multiprocessor computer system may comprise cache memory. The cache memory may be utilized to store instructions and/or data, which are utilized by the processors when executing process tasks. The cache memory may also be utilized to store metadata associated with the process tasks. For example, in a process task related to a network application, such as TCP, metadata may comprise data that enable the exchange of data packets via a network. Such metadata may include parameters for sequence numbering of outgoing data packets, expected next sequence numbering for received data packets, determination of window sizes that enable retransmission of previously transmitted outgoing data packets and/or acknowledgment of previously received data packet. For example, an RX completion event may cause the TCP application to perform processing, which enable the generation of an acknowledgment of the received data packet. During the acknowledgment processing by the TCP application, metadata associated with the TCP application may be modified. The modified data may be utilized when transmitting subsequent data packets. In some OS environments data may be sent as an action triggered by the reception of ACKs on previous sends.

The cache memory may comprise a hierarchy of cache levels, where each cache level may be associated with distinct attributes. For example, higher levels in the cache hierarchy may comprise smaller memory capacity but shorter data access times. The cache memory may be distributed among hardware components. For example, each processor may comprise one or more cache memory components. The processor may store instructions and/or data within its cache, which has been retrieved from main memory, which may comprise memory circuitry such as dynamic random access memory (DRAM) circuitry. The main memory resources may be commonly shared among the processors. The OS may comprise a memory management module that may manage the access to main memory for the processors. Typically there is an MMU (Memory Management Unit) in the CPU, which relies heavily on the OS to maintain address tables. Typically the tables are the same for all CPUs (but actual cache content is not)

The instructions, data and metadata associated with a process may be associated with a process control block (PCB). The PCB comprises information, which enables a processor to execute a process task. The PCB for a given process task, PT_1, may be referred to as PCB_1. When a scheduler assigns process task PT_1 to a processor_A, the processor_A may be provided a pointer, which enables the processor_A to access PCB_1. The accessed PCB_1 may be retrieved from main memory by the processor_A. At least a portion of the data stored and/or referred to by PCB_1 may be stored within the processor_A cache memory, cache_A. The processor_A may then utilize information within PCB_1 to execute the assigned process task. Alternatively, the processor_A may anticipate that it will be assigned process task PT_1. In that case, the processor_A may access, or fetch, the instructions, data and/or metadata associated with the PCB_1. Then, when the scheduler assigns the process task PT_1 to the processor_A, the processor_A may already have stored the PCB_1 within cache_A. The pre-fetching of instructions, data and/or metadata associated with a PCB prior to being assigned the process task by the scheduler may be referred to as cache pre-heating. Usually, prefetching of data is done using the assumption that a process is likely to access the data immediately after the data that was most recently accessed. Some CPUs use “stride detection” to allow detecting of more complex data access patterns. Prefetching of instructions is done using a “branch prediction” unit, for example.

During execution of the process task PT_1, the processor_A may modify data and/or metadata stored within cache_A. The modified data and/or metadata within the cache_A may be stored, or written back, to memory locations within main memory. A unit of data, which may be written back from cache_A to main memory, may be referred to as a cache line. A cache line which refers to a contiguous “chunk” of locations in main memory. Because data and/or metadata associated with PCB_1 may be modified and written back to main memory during the execution of the process task PT_1 by processor_A, the memory management module may “lock” address locations within main memory from which the data and/or metadata were retrieved. The locking of the main memory locations may prevent other processors from modifying data within the locked main memory locations while the processor_A is executing the assigned process task, PT_1. This can have a significant impact on performance. Sometimes the lock is on the whole memory bus preventing any memory access until the operation completes.

The scheduler may assign the process task PT_2 to a processor_B based on a criterion of even distribution of workload among processors. For example, the scheduler may assign a process task, PT_1, associated with a RX completion event to processor_A, while assigning a corresponding process task, PT_2, which leads to the generation of a TX completion event, to processor_B. The process task PT_2 may utilize data and/or metadata associated with the process control block PCB_1. When the processor_B attempts to modify data and/or metadata associated with PCB_1, the memory management module may block the attempt by processor_B to modify the data and/or metadata when the processor_B attempts to access one or more memory locations within main memory, which are locked to processor_A. In this case, the processor_B may wait until the memory locations are unlocked before being able to continue execution of the process task PT_2. This condition, in which a processor_B is blocked in execution of an assigned process task PT_2 due to an inability to modify data locked by a processor_A may be referred to as cache line bouncing.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A scheduler hint method and system to improve network interface controller (NIC) receive (RX) processing cache performance, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary multiprocessor system, which may be utilized in connection with an embodiment of the invention.

FIG. 2 is a block diagram of an exemplary processor, which may be utilized in connection with an embodiment of the invention.

FIG. 3 is an illustration of an exemplary scheduler hint method, in accordance with an embodiment of the invention.

FIG. 4 is a flowchart illustrating exemplary steps for a scheduler hint method with modified process assignment parameters, in accordance with an embodiment of the invention.

FIG. 5 is a flowchart illustrating exemplary steps for a scheduler hint method with a modified computed score value, in accordance with an embodiment of the invention.

FIG. 6 is a flowchart illustrating exemplary steps for a scheduler hint method with addition of process assignment parameters, in accordance with an embodiment of the invention.

### DETAILED DESCRIPTION OF THE INVENTION

Certain embodiments of the invention may be found in a scheduler hint method and system to improve network interface controller (NIC) receive (RX) processing cache performance. The hint is triggered on the RX path but the gain is also on the TX side. In an exemplary embodiment of the invention, an interrupt event may cause a scheduler to assign a process task to a specific processor within a multiprocessor system. The specific processor may utilize instructions, data and/or metadata, which are referenced by a process control block (PCB) that is associated with the assigned process task. The processing of the process task may result in the invocation of one or more subsequent process tasks. The one or more subsequent process tasks may utilize instructions, data and/or metadata that were utilized in the initial process task. The one or more subsequent process tasks may go to sleep pending further execution at a later time. In various embodiments of the invention, the original interrupt event may pass data to the OS, which will cause the scheduler to wake up sleeping processes and to assign the awakened process tasks for execution on the same processor, which executed the initial process task. The data, which enables the scheduler to assign the subsequent process tasks to the same processor, may be referred to as a “scheduler hint”. Various embodiments of the invention may also be practiced with other types of I/O systems, such as disk I/O systems.

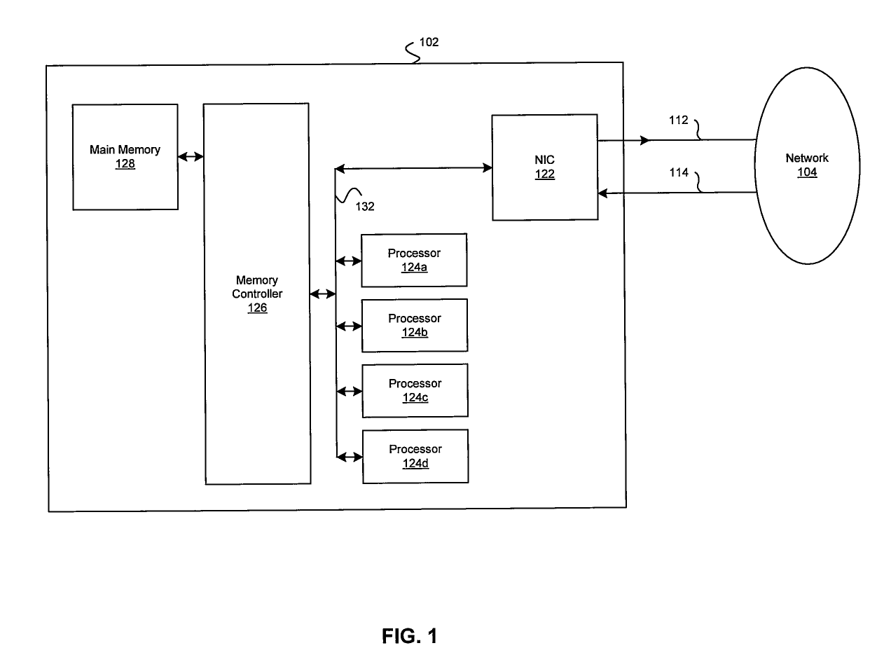

FIG. 1 is a block diagram of an exemplary multiprocessor system, which may be utilized in connection with an embodiment of the invention. Referring to FIG. 1, there is shown a multiprocessor system 102 and a network 104. The multiprocessor system 102 may comprise a receive (RX) interface 112 and a transmit (TX) interface 114. The RX interface 112 may enable the multiprocessor system 102 to receive data packets from the network 104. The TX interface 114 may enable the multiprocessor system to transmit data packets to the network 104. The multiprocessor system 102 may comprise a network interface controller (NIC) 122, a plurality of processors 124a, 124b, 124c and 124d, a memory controller 126 and a main memory 128. The NIC 122, processors 124a, 124b, 124c and 124d and memory controller 126 may communicate via a bus 132.

The NIC 122 may comprise suitable logic, circuitry and/or code that may enable the multiprocessor system 102 to communicate data via a network 104. The NIC 122 may implement protocols, which comprise various levels in an applicable protocol reference model (PRM) such as specified, for example, by the International Organization for Standardization (ISO). Specifications for many network protocols are defined by the Internet Engineering Task Force (IETF). The NIC 122 may implement various physical (PHY) layer protocols that enable the NIC 122 to transmit and/or receive signals via a physical TX interface 114 and/or physical RX interface 112. Exemplary physical TX and/or RX interfaces may comprise category 5 (CAT5) twisted pair copper cable, coaxial cable and optical fiber cable. The NIC 122 may also implement media access control (MAC) layer protocols such as collision sense multiple access with collision detection (CSMA/CD), CSMA with collision avoidance (CSMA/CA) and token ring. The NIC 122 may also implement network layer protocols such as Internet Protocol (IP) and internetwork packet exchange (IPX) protocol. When receiving data packets via the network 104, the NIC 122 may extract payload portions of the received data packets and transmit the extracted payload portions via the bus 132. When transmitting data packets via RX interface 114 to the network 104, the NIC 122 may receive payload portions for insertion into transmitted data packets via the bus 132. The NIC 122 may encapsulate the payload portions within one or more data packets, which may then be transmitted via the TX interface 112 to the network 104.

The processor 124a may comprise suitable logic, circuitry and/or code that may execute code to perform operations on data. The processor 124a may execute operating system (OS) code. The OS code may enable the processor 124a to execute various process tasks. The process tasks may represent instances of code related to higher layer protocol entities in PRM, such as transport layer code and application code. Examples of transport layer code may comprise the transport layer protocol (TCP) and the user datagram protocol (UDP). Examples of application code may comprise electronic mail (email), or various web browser applications. The processors 124b, 124c and 124d may be substantially similar to the processor 124a.

The OS may comprise a multiprocessor OS, which may enable the processors 124a, 124b, 124c and 124d to collaboratively execute code and to perform operations on data. The multiprocessor OS may comprise a scheduler, which enables the scheduling and assignment of process tasks to individual processors for determined time durations, and a memory management module, which enables the collaborative utilization of memory resources within the multiprocessor system 102.

The memory controller 126 may comprise suitable logic, circuitry and/or code, which may control the flow of data between the bus 132 and main memory 128. The memory controller 126 may generate signals, which enable data to be stored to and/or retrieved from the main memory 128. When the main memory 128 comprises dynamic random access memory (DRAM), the memory controller 126 may generate refresh signals. The memory controller 126 may comprise multiplexer and/or demultiplexer circuitry, which enables adaptation of the data width of the main memory 128 to the data width of the bus 132.

The main memory 128 may comprise suitable logic, circuitry and/or code that may enable the storage of data and/or code. The main memory 128 may utilize various technologies for storage of data including various random access memory (RAM) technologies, such as static RAM (SRAM) and DRAM, various read only memory (ROM) technologies, such as electrically erasable programmable ROM (EEPROM) and/or flash memory, for example. The main memory 128 may comprise one or more integrated circuit (IC) devices and/or various disk drive devices.

In various embodiments of the invention, the NIC 122 may receive a data packet from the network 104 via the RX interface 114. An IP instance, for example an IP process, associated with the NIC may generate an RX completion interrupt event. The interrupt event may be communicated via the bus 132 to the processors 124a, 124b, 124c and 124d. The interrupt event may comprise data that enables the multiprocessor OS to associate a transport layer protocol instance, for example a TCP process, with the interrupt event. A scheduler, executing within the multiprocessor OS, may invoke an interrupt service routine (ISR). The ISR may invoke a receive system call (syscall) function, which invokes services from the OS to enable assignment of a process task, PT_1, associated with the TCP process, to processor 124a for execution. The scheduler may assign the process task PT_1, also referred to as an ingress process task, to the processor 124a based on data stored within the process control block (PCB), PCB_1, for process task PT_1. The processor 124a may retrieve the PCB_1 from memory locations within main memory 128. The processor 124a may access blocks of data from main memory 128 in units of cache lines. For example, a cache line may comprise a 16 octet block of data stored at memory locations within the main memory 128. The cache lines may be stored within the processor 124a in cache memory. The processor 124a may communicate address and instruction signals to the memory controller 126, which may retrieve data from the reference address locations and communicate the retrieved data to the processor 124a via the bus 132. The memory management module within the OS may “lock” the address locations within the main memory 128 from which the PCB_1 was retrieved to prevent other processors 124b, 124c and/or 124d from modifying data within the address locations. On some processors, this is done by “snooping” in which the CPU listens on the bus for transactions on memory addresses that are cached, when it “sees” one it will lock the memory arbitrator until it had finished writing the “dirty” cache line back to main memory.

The TCP process task executing on processor 124a, PT_1, may invoke a transmit syscall on behalf of a process task, for example PT_2, for a TCP process to generate an acknowledgment (ACK) message in response to the received data packet. The ACK message may not be transmitted by the NIC 122 immediately, but may be delayed pending some future event. For example, the ACK message may be sent, or “piggybacked”, within a data packet to be transmitted at a later time by the NIC 122 via the TX interface 112 to the network 104. In such case, execution of the process task PT_2 may be delayed and the process task put to sleep. ACKs are commonly piggybacked on window updates, which allows the other side to send more data. Window updates happen when the process is done receiving part of the data. The process is usually put to sleep pending more RX data while waiting for the other side to announce an updated window, which would enable the sending of more TX data.

In various embodiments of the invention, the IP process, which generated the original RX interrupt event, may pass hint data to the scheduler. The hint data may be utilized by the scheduler to enable scheduling of the awakening process task PT_2 for execution on the processor 124a, instead of to one of the other processors 124b, 124c or 124d. In many cases, the process task PT_2 may utilize data and/or metadata, associated with PCB_1, which is stored in the cache memory within the processor 124a for the processing of process task PT_1. Consequently, the scheduler hint data may reduce the likelihood of cache bouncing. The scheduler hint data may also improve the performance of the NIC for RX and/or TX processing of data packets. Various embodiments of the invention may also enable improved benefits to NIC processing performance as a result of cache preheating. For example, in various embodiments of the invention, the processor 124a may store a larger number of cache lines during cache preheating. This, in turn, may increase the likelihood that data utilized during ingress and/or egress processing is already stored within cache memory, which may avoid delays resulting from retrieval of data from main memory 128 during the execution of process tasks. Having both sides of the protocol run on the same CPU is likely to improve the chance of data used in one side to still be available when the next side is run.

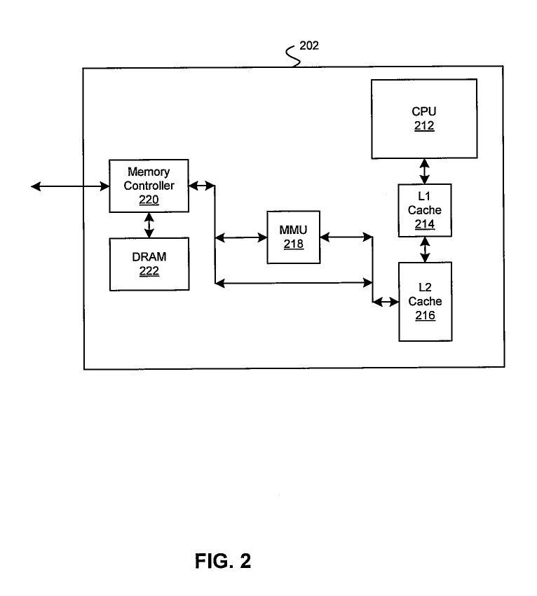

FIG. 2 is a block diagram of an exemplary processor, which may be utilized in connection with an embodiment of the invention. Referring to FIG. 2, there is shown a processor 202. The processor 202 may be exemplary of the processors 124a, 124b, 124c and/or 124d. The processor 202 may comprise a central processing unit (CPU) 212, a level 1 (L1) cache memory 214, a level 2 (L2) cache memory 216, a memory management unit 218 and a memory (I/O) controller 220.

The CPU 212 may comprise suitable logic, circuitry and/or code that may enable processing of data. The CPU 212 may comprise a control unit, which enables the CPU 212 to interpret code to generate instructions, and an arithmetic logic unit (ALU), which processes data based on the generated instructions. The CPU 212 may also comprise various registers, which enable the storage of data and/or instructions that are utilized during the operation of the CPU 212. The rate at which the CPU 212 may execute instructions may be determined based on the cycle time for a clock signal.

The L1 cache 214 may comprise suitable logic, circuitry and/or code that may enable storage of data, metadata and/or code. The L1 cache 214, which may also be referred to as a “primary” cache, may comprise circuitry, which enables fast access to stored data. The access time for data stored in the L1 cache 214 may be approximately equal to the clock cycle time for the CPU 212. A unit of data stored and/or retrieved from the L1 cache 214 may be referred to as a cache line.

The L2 cache 216 may be substantially similar to the L1 cache 214. The L2 cache 216 may comprise a larger data storage capacity relative to the L1 cache 214. The L2 cache 216 may also have a longer data access time relative to the L1 cache 214. A unit of data stored and/or retrieved from the L2 cache 216 may be referred to as a cache line.

The MMU 218 may comprise suitable logic, circuitry and/or code that may enable controlled access to stored data. The MMU 218 may enable translation of virtual memory addresses, which may be utilized within code, to physical memory addresses, which may be utilized to retrieve data from a physical memory device, such as main memory 128. On machines that have an MMU, processes only use virtual addresses, which the MMU translates into physical addresses.

The memory controller 220 may comprise suitable logic, circuitry and/or code that may enable the processor 202 to receive data, metadata and/or instructions via the bus 132 and/or to send data, metadata and/or instructions via the bus 132. The memory controller 220 may select a data source module within the processor 202, which may enable the selected data source module to send data, metadata and/or instructions via the bus 132. The memory controller 220 may select a data destination module within the processor 202, which may enable the selected data destination module to receive data, metadata and/or instructions via the bus 132. The memory controller 220 may also access DRAM 222 within the processor 202.

The L1 cache 214 and L2 cache 216 may be components within a multilayer cache memory. The L1 cache 214 may retrieve data, metadata and/or instructions from the L2 cache 216. The L2 cache 216 may receive data, metadata and/or instructions from the L1 cache 214. The CPU 212 may retrieve data, metadata and/or instructions from the L1 cache 214. The CPU 212 may store data, metadata and/or instructions retrieved from cache memory within one or more registers. A cache “hit” may occur when the CPU 212 is able to retrieve data, metadata and/or instructions that are stored in the L1 cache 214 or the L2 cache 216. A cache “miss” may occur when the CPU 212 attempts to retrieve data, metadata and/or instructions, which are not currently stored in the L1 cache 214 or the L2 cache 216. When a cache miss occurs, the CPU 212 may generate a virtual address location for the data, metadata and/or instructions that are sought by the CPU 212. The CPU 212 may communicate the virtual address to the MMU 218, which may generate a physical address. The physical address may indicate a memory location within the main memory 128 at which the data, metadata and/or instructions may be stored. The MMU 218 may send the physical address to the memory controller 220. The memory controller 220 may send the physical address to the bus 132, which may enable the data to be retrieved from main memory 128. Upon receipt of the data from main memory 128, the I/O controller may send the data to the L1 cache 214.

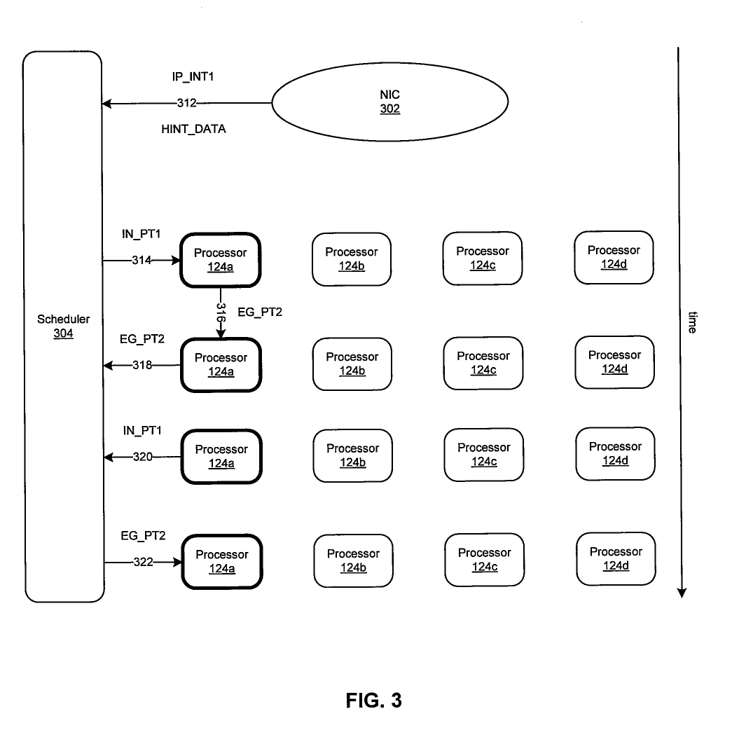

FIG. 3 is an illustration of an exemplary scheduler hint method, in accordance with an embodiment of the invention. Referring to FIG. 3, a NIC 122 may receive data packets via the RX interface 112. A NIC 302, associated with a network layer protocol instance (for example IP), may generate an interrupt event, IP_INT1. The interrupt event IP_INT1 may be communicated to a scheduler 304 in step 312. The interrupt event IP_INT1 may refer to a TCP process. The scheduler 304 may invoke a deferred procedure call (DPC), for example an ingress process task, IN_PT1, to enable processing of the received data packets. In step 314, the scheduler 304 may determine based on data contained within the process control block PCB_PT1, associated with the ingress process task IN_PT1, that the ingress process task IN_PT1 is to be scheduled for execution on processor 124a. The PCB_PT1 and associated data and/or metadata may be stored in L1 cache memory 214 within the processor 124a. Locations within main memory 128 from which the PCB_PT1 and associated data were fetched, may be locked by the memory management module within the multiprocessor OS to enable the processor 124a to modify the locked memory locations but prevent other processors 124b, 124c and/or 124d from modifying the locked memory locations.

The ingress process task IN_PT1 may queue the received data packets for processing by the processor 124a. In step 316, the ingress process task IN_PT1 may result in generation of an egress process task, EG_PT2, for example an ACK process, to process ACK messages generated in response to the received data packets. The processor 124a may suspend execution of the egress process task EG_PT2. In step 318, the suspension of execution of the egress process task EG_PT2 by the processor 124a may be communicated to the scheduler 304. The egress process task EG_PT2 may be put to sleep by the scheduler 304. In some OS environments the process is put to sleep when it “blocks” on trying to read/write more than it can at the moment. At a later time instant, in step 320, the processor 124a may indicate completion of execution of the ingress process task IN_PT1 to the schedule module 304. The completion of the ingress process task, IN_PT1, may enable the scheduler 304 to awaken the egress process task EG_PT2 and attempt to schedule awakened EG_PT2 for execution on one of the processors 124a, 124b, 124c or 124d. In some OS environments the stack DPC will wake up the user process that was earlier put to sleep, when an awaited-for event has occurred. The ACK message processing performed by the egress process task EG_PT2 may result in modification of, for example, metadata associated with the PCB_PT1. Metadata for a TCP process may comprise, for example, an acknowledgment counter value, which indicates sequence numbers for received packets that are to be acknowledged.

In various embodiments of the invention, the NIC process may communicate hint data, HINT_DATA in step 312. The HINT_DATA may be utilized by the scheduler 304 when scheduling the awakened egress process task EG_PT2 for execution on one of the processors 124a, 124b, 124c or 124d. In various embodiments of the invention, the HINT_DATA may bias the scheduler 304 to assign the awakened process task EG_PT2 for execution on the same processor 124, which executed the ingress process task IN_PT1. In step 322, the HINT_DATA may bias the scheduler 304 to assign the awakened egress process task EG_PT2 for execution on processor 124a. By assigning the egress process task EG_PT2 for execution on the processor 124a, the scheduler 304 may enable an avoidance of cache bouncing, which may occur in the case where the egress process task EG_PT2 may be assigned for execution on another processor, for example, processor 124b.

Various embodiments of the invention may utilize any of a plurality of methods to bias the scheduler 304 to assign an awakening process task to a preferred processor. In an exemplary embodiment of the invention, the HINT_DATA may modify change affinity data, which may be stored in connection with the multiprocessor OS and utilized by the scheduler 304 when assigning process tasks to processors. For example, the scheduler 304 may maintain a process table that lists current process tasks, both awake and asleep. Associated with each process task in the process table may be change affinity data, which indicates a preferred processor to which the process task should be assigned. In various embodiments of the invention, the HINT_DATA may enable change affinity data to be modified within the process table for selected process task(s) so as to increase the likelihood that the scheduler 304 may assign the awakened selected process task(s) to a specified processor for execution.

In another exemplary embodiment of the invention, the scheduler 304 may generate hash table values based on various parameters. The parameters may vary for each process task listed in the process table. Exemplary parameters may comprise the measured idle time for each of the processors, an indication of the current busy/idle status for each of the processors, in addition to various statistically determined values, which the scheduler 304 may utilize for evenly distributing processing loads among the processors. Statistically determined values may be based on factors such as the nature of the process task (i.e. whether it is a batch process or interactive process) or the amount of time for which the task process has been waiting for user input or for network traffic. The HINT_DATA may comprise additional parameters, which the scheduler 304 may utilize for scheduling awakening process tasks to selected processors for execution.

Various embodiments of the invention for a scheduler hint method and system to improve NIC RX processing cache performance may comprise modifying parameters that the scheduler 304 utilizes when assigning awakening process tasks for execution on one of a plurality of processors in a multiprocessor system 102. In various embodiments of the invention, an ingress process task that results from NIC 122 reception of data packets may execute on a specified processor. The ingress process task may result in the generation of one or more egress process tasks. The egress process tasks may be put to sleep by the scheduler 304. A network layer process instance, which generated interrupt events in response to reception of the data packets, may communicate HINT_DATA to the scheduler 304, which may result in modification of one or more parameters that the scheduler 304 utilizes when assigning awakening process tasks for execution on one of processors. Upon awakening of the egress process tasks, the scheduler 304 may assign the awakening egress process tasks for execution on the specified processor that executed the ingress process task based on the parameter values, which were modified based on the HINT_DATA.

Various embodiments of the invention for a scheduler hint method and system to improve NIC RX processing cache performance may comprise modifying a computed score value, which is computed based on one or more parameters. The scheduler 304 may utilize the score value when assigning awakening process tasks for execution on one of a plurality of processors in a multiprocessor system 102. In various embodiments of the invention, an ingress process task that results from NIC 122 reception of data packets may execute on a specified processor. The ingress process task may result in the generation of one or more egress process tasks. The egress process tasks may be put to sleep by the scheduler 304. A network layer process instance, which generated interrupt events in response to reception of the data packets, may communicate HINT_DATA to the scheduler 304, which may result in modification of a computed score value. Upon awakening of the egress process tasks, the scheduler 304 may assign the awakening egress process tasks for execution on the specified processor that executed the ingress process task based on the computed score value, which was modified based on the HINT_DATA.

Various embodiments of the invention for a scheduler hint method and system to improve NIC RX processing cache performance may comprise the inclusion of additional parameters that the scheduler 304 may utilize when assigning awakening process tasks for execution on one of a plurality of processors in a multiprocessor system 102. In various embodiments of the invention, an ingress process task that results from NIC 122 reception of data packets may execute on a specified processor. The ingress process task may result in the generation of one or more egress process tasks. The egress process tasks may be put to sleep by the scheduler 304. A network layer process instance, which generated interrupt events in response to reception of the data packets, may communicate HINT_DATA to the scheduler 304, which may result in the determination of values for the one or more additional parameters that the scheduler 304 may utilize when assigning awakening process tasks for execution on one of processors. Upon awakening of the egress process tasks, the scheduler 304 may assign the awakening egress process tasks for execution on the specified processor that executed the ingress process task based on the one or more additional parameter values, which were determined based on the HINT_DATA.

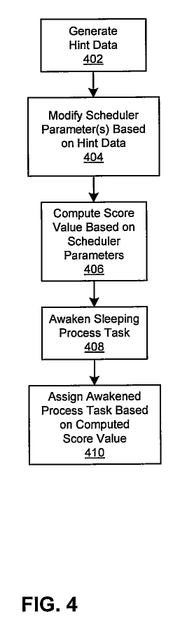

FIG. 4 is a flowchart illustrating exemplary steps for a scheduler hint method with modified process assignment parameters, in accordance with an embodiment of the invention. Referring to FIG. 4, in step 402 a NIC process may generate hint data. In step 404, the hint data may be utilized to modify one or more scheduler parameters. In step 406, a score value may be computed based on a set of scheduler parameters, which may comprise the modified scheduler parameters. In step 408, the scheduler 304 may awaken a sleeping process task. In step 410, the scheduler 304 may assign the awakened process task to a processor for execution based on the computed score value.

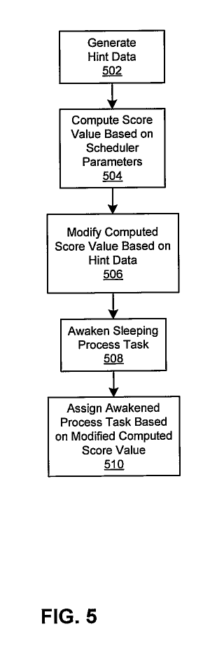

FIG. 5 is a flowchart illustrating exemplary steps for a scheduler hint method with a modified computed score value, in accordance with an embodiment of the invention. Referring to FIG. 5, in step 502 a NIC process may generate hint data. In step 504, a score value may be computed based on a set of scheduler parameters. In step 506, the computed score value may be modified based on the hint data. In step 508, the scheduler 304 may awaken a sleeping process task. In step 510, the scheduler 304 may assign the awakened process task to a processor for execution based on the modified computed score value.

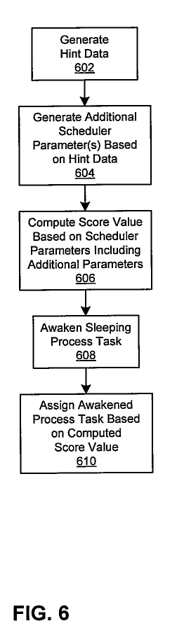

FIG. 6 is a flowchart illustrating exemplary steps for a scheduler hint method with addition of process assignment parameters, in accordance with an embodiment of the invention. Referring to FIG. 6, in step 602 a NIC process may generate hint data. In step 604, the hint data may be utilized to generate one or more additional scheduler parameters. In step 606, a score value may be computed based on a set of scheduler parameters, which may comprise the generated additional scheduler parameters. In step 608, the scheduler 304 may awaken a sleeping process task. In step 610, the scheduler 304 may assign the awakened process task to a processor for execution based on the computed score value.

Aspects of a scheduler hint method and system to improve network interface controller (NIC) receive (RX) processing cache performance may include a NIC 122 that enables generation of a processor selection bias value. The processor selection bias value may comprise hint data. A scheduler 304 within a multiprocessor operating system (OS) executing on a multiprocessor computing system 102 may enable selection of one of a plurality of processors based on the generated processor selection bias value. The scheduler 304 executing on the multiprocessor computer system 102 may enable execution of specified code, for example an egress process task, on the selected one of the plurality of processors, for example processor 124a. The egress process task may be executing subsequent to an ingress task process, which was executed on the selected one of the plurality of processors in response to one or more data packets received at the NIC 122.

The scheduler 304 enable selection of one of the plurality of processors based on a computed score value. The computed score value may be modified based on the generated processor selection bias value.

The scheduler 304 may enable determination of the computed score value based on a plurality of scheduler parameters. At least a portion of the plurality of scheduler parameters may be modified based on the generated processor selection bias value.

The generated processor selection bias value may be utilized to enable generation of one or more additional scheduler parameters. The scheduler 304 may enable determination of the computed score value based on the plurality of scheduler parameters and the generated one or more additional scheduler parameters.

The scheduler 304 may enable determination of a busy status for the selected one of said plurality of processors at a determined time instant. The specified code may be assigned for execution on the selected one of the plurality of processors based on the busy status determination. The scheduler 304 may enable execution of the specified code on the selected one of the plurality of processors following the assignment. The scheduler 304 may enable assignment, at a subsequent time instant, of the specified code for execution on the selected one of the plurality of processors based on the busy status determination. For example, in instances when the processor 124a may be currently busy at the time that the busy status determination is made, the scheduler 304 may assign an egress process task to a processor 124a at a subsequent time instant when the processor 124a becomes idle.

Another embodiment of the invention may provide a machine-readable storage, having stored thereon, a computer program having at least one code section executable by a machine, thereby causing the machine to perform the steps as described herein for a scheduler hint method and system to improve network interface controller (NIC) receive (RX) processing cache performance.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing data, the method comprising:
generating a processor selection bias value;
selecting one of a plurality of processors in a multiprocessor computing system based on said generated processor selection bias value; and
executing specified code on said selected one of said plurality of processors.

2. The method according to claim 1, comprising selecting said one of said plurality of processors based on a computed score value.

3. The method according to claim 2, comprising modifying said computed score value based on said generated processor selection bias value.

4. The method according to claim 2, comprising determining said computed score value based on a plurality of scheduler parameters.

5. The method according to claim 4, comprising modify a value for at least a portion of said plurality of scheduler parameters based on said generated processor selection bias value.

6. The method according to claim 4, comprising generating one or more additional scheduler parameters based on said generated processor selection bias value.

7. The method according to claim 6, comprising determining said computed score value based on said plurality of scheduler parameters and said generated one or more additional scheduler parameters.

8. The method according to claim 1, comprising determining a busy status for said selected one of said plurality of processors at a determined time instant.

9. The method according to claim 8, comprising assigning said specified code for execution on said selected one of said plurality processors based on said busy status determination.

10. The method according to claim 9, comprising executing said specified code on said selected one of said plurality of processors following said assigning.

11. The method according to claim 8, comprising assigning, at a subsequent time instant, said specified code for execution on said selected one of said plurality of processors based on said busy status determination.

12. A system for processing data, the system comprising:
one or more circuits that enable generation of a processor selection bias value;
said one or more circuits enable selection of one of a plurality of processors in a multiprocessor computing system based on said generated processor selection bias value; and
said one or more circuits enable execution of specified code on said selected one of said plurality of processors.

13. The system according to claim 12, wherein said one or more circuits enable selection of said one of said plurality of processors based on a computed score value.

14. The system according to claim 13, wherein said one or more circuits enable modification of said computed score value based on said generated processor selection bias value.

15. The system according to claim 13, wherein said one or more circuits enable determination of said computed score value based on a plurality of scheduler parameters.

16. The system according to claim 15, wherein said one or more circuits enable modification of a value for at least a portion of said plurality of scheduler parameters based on said generated processor selection bias value.

17. The system according to claim 15, wherein said one or more circuits enable generation of one or more additional scheduler parameters based on said generated processor selection bias value.

18. The system according to claim 17, wherein said one or more circuits enable determination of said computed score value based on said plurality of scheduler parameters and said generated one or more additional scheduler parameters.

19. The system according to claim 12, wherein said one or more circuits enable determination of a busy status for said selected one of said plurality of processors at a determined time instant.

20. The system according to claim 19, wherein said one or more circuits enable assignment of said specified code for execution on said selected one of said plurality processors based on said busy status determination.

21. The system according to claim 20, wherein said one or more circuits enable execution of said specified code on said selected one of said plurality of processors following said assignment.

22. The system according to claim 19, wherein said one or more circuits enable assignment, at a subsequent time instant, of said specified code for execution on said selected one of said plurality of processors based on said busy status determination.
